(19) United States
(12) Patent Application Publication
(10) Pub. No.: US 2026/0312201 A1
(43) Pub. Date: Oct. 8, 2026

(54) SPACER FOR A BATTERY CELL STACK

(71) Applicant: JAGUAR LAND ROVER LIMITED, Whitley, Coventry, Warwickshire (GB)

(72) Inventors: Ahmed ABAZA, Whitley, Coventry, Warwickshire (GB); Paul HANEY, Whitley, Coventry, Warwickshire (GB)

(21) Appl. No.: 19/482,154

(22) PCT Filed: May 23, 2024
(86) PCT No.: PCT/EP2024/064261

§ 371 Date: Nov. 6, 2025

(30) Foreign Application Priority Data
May 24, 2023 (GB) 2307796.9

(51) Int. Cl. H01M 50/242; H01M 10/658; H01M 50/249; H01M 50/291; H01M 50/293

(52) U.S. Cl. CPC H01M 50/242; H01M 10/658; H01M 50/249; H01M 50/291; H01M 50/293; H01M 2220/20

(57) ABSTRACT

A spacer for positioning between two adjacent battery cells of a battery cell stack includes a compressible pad and a support element supporting the compressible pad. The compressible pad and the support element are configured to be at least partly compressed between adjacent battery cells of the battery cell stack.

### TECHNICAL FIELD

The present disclosure relates to a spacer for a battery cell stack. Aspects of the invention relate to a spacer for positioning between two adjacent battery cells of a battery cell stack, a battery cell stack, a battery comprising a battery cell stack and a vehicle comprising a battery cell stack or a battery.

### BACKGROUND

It is known to provide battery cells in parallel to form a battery cell stack. Battery cells in such stacks abut each other and generally need to be held in a housing or casing, which adds to the space envelope occupied by batteries as well as their weight. During thermal events, heat can spread between battery cells in this configuration. Similarly, because the battery cells are in physical contact there is a potential for short circuits to occur.

It is an aim of the present invention to address one or more of the disadvantages associated with the prior art.

### SUMMARY OF THE INVENTION

Aspects and embodiments of the invention provide a spacer for positioning between two adjacent battery cells of a battery cell stack, a battery cell stack, a battery, a battery and a vehicle as claimed in the appended claims.

According to an aspect of the present invention there is provided a spacer for a battery cell stack. The spacer may be a spacer for positioning between two adjacent battery cells of a battery cell stack. The spacer may comprise a compressible pad and a support element supporting the compressible pad.

The support element beneficially provides structural integrity for a battery cell stack such that the requirement for housing is eliminated or at least reduced.

The compressible pad and the support element may be configured to be located between adjacent battery cells of a battery cell stack. The compressible pad and the support element may be configured to be at least partly compressed between adjacent battery cells, for example two adjacent battery cells of a battery cell stack.

Advantageously, the support element can be compressed during manufacture to account for variances in the size of battery cells in a battery cell stack. Battery cells expand during use and over the course of their life. The compressible pad is constructed to deform as the battery cells expand, thereby providing a volume within a battery cell stack for the expanded the battery cells whilst maintaining a thermal and electrical barrier between the battery cells.

According to another aspect of the invention there is provided a spacer for positioning between two adjacent battery cells of a battery cell stack, the spacer comprising: a compressible pad; and a support element supporting the compressible pad, wherein the compressible pad and the support element are configured to be at least partly compressed between two adjacent battery cells of a battery cell stack.

Advantageously, the support element provides structural integrity for a battery cell stack such that the requirement for housing is eliminated or at least reduced. Additionally, the support element can be compressed during manufacture to account for variances in the size of battery cells in a battery cell stack. Battery cells expand during use and over the course of their life. The compressible pad is constructed to deform as the battery cells expand, thereby providing a volume within a battery cell stack which the expanded battery cells can expand into whilst maintaining a thermal and electrical barrier between the battery cells.

In an embodiment, the compressible pad comprises two faces. Each face of the compressible pad may be configured to abut a face of a battery cell of the battery cell stack.

Advantageously, the compressible pad can slot (i.e. be positioned) between two battery cells. As the battery cells expand over time, the additional volume required by the battery cells can be accommodated by compression of the compressible pad.

In an embodiment, the compressible pad comprises an adhesive on at least one face of the compressible pad. The adhesive may be, for example, configured to at least partly adhere the spacer to a first battery cell of the two adjacent battery cells.

Beneficially, the adhesive enables the spacer to be connected or fixed to a battery cell without the need for a housing or casing. In other words, the spacer and battery cell are self-supporting.

The spacer may comprise the adhesive on each face of the compressible pad. The adhesive may be configured to at least partly adhere the spacer to the first battery cell and a second battery cell of the two adjacent battery cells.

Advantageously, providing adhesive on each of the faces of the compressible pad increases the structural rigidity of the spacer and battery cells.

The adhesive may be an adhesive layer, for example an adhesive tape, such as a double-sided adhesive tape. The adhesive, for example the adhesive layer, may secure the compressible pad relative to the support element and/or enable attachment of the spacer to one or more battery cells.

The use of an adhesive layer, for example an adhesive tape, is an efficient way to secure the compressible pad relative to the support element and/or enable the attachment of the spacer to one or more battery cells without the need for additional casing or housing components.

In an embodiment, the support element has a first compressibility and the compressible pad has a second compressibility. The first compressibility may be lower than the second compressibility. In an embodiment, the first compressibility (i.e. the compressibility of the support element) may be 10 to 100 times lower than the second compressibility (i.e. the compressibility of the compressible pad). The first compressibility (i.e. the compressibility of the support element) may be lower than the second compressibility (i.e. the compressibility of the compressible pad) at standard operating temperatures of a battery cell stack or a battery with which the spacer is used. The standard operating temperatures of the battery cell stack or the battery may be from approximately −50° C. to approximately 100° C., for example from approximately −40° C. to approximately 50° C.

Advantageously, the additional volume required by the expanded battery cells is accommodated by the compressible pad in preference to the support element since the compressible pad has a higher compressibility than the support element.

In an embodiment, the elastic modulus of the support element may be approximately 10 to approximately 150 MPa.

Advantageously, the elastic modulus of the support element is high enough to provide mechanical integrity and resist delamination under vibration and low enough to enable compression and prevent damage to battery cells.

In an embodiment, the compressible pad is attached to the support element. The support element may be, for example, fixedly attached to and supporting the compressible pad.

The attachment of the compressible pad to the support element advantageously ensures that the support element supports the compressible pad.

In an embodiment, the support element is a frame. The frame may, for example, at least partly surround a perimeter, e.g. an outer perimeter, of the compressible pad. The frame may extend around an entire perimeter, e.g. an entire outer perimeter, of the compressible pad.

In an embodiment, the support element may define a central aperture within which the compressible pad is located.

The frame advantageously supports the compressible pad, in particular the outer periphery of the compressible pad.

In an embodiment, the compressible pad comprises an anti-thermal propagation material. Additionally or alternatively, the compressible pad may comprise a dielectric material. The compressible pad may comprise an electrically insulating material.

In this way, the spacer beneficially enables adjacent battery cells to be thermally and/or electrically insulated or separated.

In an embodiment, the support element comprises a thermoplastic elastomer.

In an embodiment, the spacer is at least 0.8 mm thick. The spacer may be at least 1 mm thick, for example at least 3 mm thick.

Either or each of the compressible pad and the support element may be at least 0.8 mm thick. Either or each of the compressible pad and the support element may be at least 1 mm thick, for example at least 3 mm thick.

Advantageously, the spacer provides structural integrity for a battery cell stack, can accommodate variances in the size of battery cells in a battery cell stack during manufacture and as a result of expansion from use and provides a thermal and electrical barrier between battery cells, whilst not occupying a significant volume or space envelope.

In an embodiment, the spacer has a spacer height, a spacer width and a spacer thickness. The support element may have a support element height, a support element width and a support element thickness. The compressible pad may have a compressible pad height, a compressible pad width and a compressible pad thickness. The spacer thickness may be at least 0.8 mm. The spacer thickness may be at least 1 mm, for example at least 3 mm. The compressible pad thickness and/or the support element thickness may be at least 0.8 mm. The compressible pad thickness and/or the support element thickness may be at least 1 mm, for example at least 3 mm thick.

The or each battery cell may have a battery cell height, a battery cell width and a battery cell thickness.

The spacer height may correspond to, or be the same as, the battery cell height. Additionally, or alternatively, the spacer width may correspond to, or be the same as, the battery cell width.

In an embodiment, the spacer height is approximately 5% greater than the battery cell height. Additionally, or alternatively, the spacer width may be approximately 5% greater than the battery cell width.

In an embodiment, the spacer thickness is less than the battery cell thickness.

In an embodiment, when compressed between the first and second battery cells, the spacer thickness is reduced by approximately 1 to 5 %.

Advantageously, the spacer provides structural integrity for a battery cell stack, can accommodate variances in the size of battery cells in a battery cell stack during manufacture and as a result of expansion from use and provides a thermal and electrical barrier between battery cells, whilst not occupying a significant volume or space envelope.

According to a further aspect of the invention there is provided a battery cell stack comprising a first spacer according to any preceding aspect of the invention. The first spacer may be sandwiched between a first battery cell and a second battery cell, for example a first battery cell and a second battery cell of the battery cell stack.

The battery cell stack may comprise a second spacer according to the preceding aspects of the invention. The second spacer may be sandwiched between one of the first battery cell and the second battery cell and a third battery cell, for example a third battery cell of the battery cell stack.

In an embodiment, the battery cell stack is a battery cell stack for a battery, for example a battery pack.

According to another aspect of the invention there is provided a battery cell stack for a battery, the battery cell stack comprising a first battery cell, a second battery cell and a spacer positioned between, for example intermediate, the first battery cell and the second battery cell, wherein the spacer comprises a compressible pad and a support element supporting the compressible pad and wherein the spacer is compressible between the first battery cell and the second battery cell.

In an embodiment, the spacer is configured to be at least partly compressed between the first battery cell and the second battery cell. The compressible pad and/or the support element of the spacer may be, for example, configured to be at least partly compressed between the first battery cell and the second battery cell.

Advantageously, the support element provides structural integrity to the battery cell stack and can accommodate different battery cell sizes, for example variations or tolerances in battery cell sizes. The compressible pad is able to compress in order to accommodate expansion of battery cells over time.

In an embodiment, each of the first battery cell and the second battery cell may comprise a first face and a second opposing face. The spacer may be compressed, for example at least partly compressed, between the first face or the second face of the first battery cell and the first face or the second face of the second battery cell. The first and second faces of each of the first and second battery cells may be substantially planar.

In an embodiment, the spacer may comprise a first surface and a second opposing surface, wherein the first surface of the spacer abuts the first face or the second face of the first battery cell and the second surface of the spacer abuts the first face or the second face of the second battery cell.

In an embodiment, the adhesive may be configured to attach the first surface of the spacer to the first face or the second face of the first battery cell and/or the adhesive may be configured to attach the second surface of the spacer to the first face or the second face of the second battery cell. The adhesive configured to attach the first surface of the spacer to the first face or the second face of the first battery cell may be a first adhesive, for example a first adhesive layer. The adhesive configured to attach the second surface of the spacer to the first face or the second face of the second battery cell may be a second adhesive, for example a second adhesive layer.

In an embodiment, the first battery cell and the second battery cell are arranged in the battery cell stack such that the first and second faces of each of the first and second battery cells are parallel.

In an embodiment, the battery cell stack comprises a support bracket. The support bracket may be attached to the spacer.

In an embodiment, the battery cell stack comprises a plurality of battery cells and a plurality of spacers, wherein each battery cell of the plurality of battery cells is separated by a spacer of the plurality of spacers.

According to another aspect of the invention there is provided a battery, for example, a battery pack comprising a battery cell stack according to the previous aspect of the invention.

According to a further aspect of the invention there is provided a vehicle comprising a battery cell stack or a battery according to the preceding aspects of the invention.

According to a yet further aspect of the present invention, there is provided a method of assembling a battery cell stack for a battery, the method comprising: providing a first battery cell, a second battery cell and a spacer, wherein the spacer comprises a compressible pad and a support element supporting the compressible pad; positioning the spacer between the first battery cell and the second battery cell; and urging the first battery cell and the second battery cell together such that the compressible pad and the support element of the spacer are at least partly compressed between the first battery cell and the second battery cell.

In an embodiment, the method comprises providing a plurality of battery cells and a plurality of spacers, wherein each battery cell of the plurality of battery cells is separated by a spacer of the plurality of spacers.

In an embodiment, the method comprises providing an adhesive and securing said battery cells to said spacer or spacers using said adhesive.

In an embodiment, the method comprises providing a jig and urging the first battery cell and the second battery cell together using the jig.

In an embodiment of the invention, the method comprises adhering or otherwise fixing a support bracket to the or each spacer.

It will be appreciated that the compressible pad may be equally referred to as a thermal barrier pad, a pad for preventing thermal propagation and/or heat runaway and a deformable pad for allowing or accommodating the expansion of battery cells.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1A shows a front view of a spacer in accordance with an embodiment of the invention;

FIG. 1B shows a side view of a spacer in accordance with an embodiment of the invention;

FIG. 1C shows an alternative front view of a spacer in accordance with an embodiment of the invention;

FIG. 1D shows a front view of a battery cell;

FIG. 2 shows a battery cell stack in accordance with an embodiment of the present invention;

FIG. 3 shows a method of making a battery cell stack according to an embodiment of the invention;

FIG. 4 shows a plurality of battery cell stacks forming a battery in accordance with an embodiment of the present invention; and

FIG. 5 shows a vehicle in accordance with an embodiment of the invention.

### DETAILED DESCRIPTION

In the following detailed description, reference is made to the accompanying figures that form a part hereof, and in which are shown by way of illustration specific embodiments in which the invention may be practiced. These embodiments are described in sufficient detail to enable those skilled in the art to practice the invention, and it is to be understood that other embodiments may be utilized and that structural, logical, and electrical changes may be made without departing from the scope of the present invention. The sequence of operations is not limited to that set forth herein and may be changed as will be apparent to those skilled in the art, with the exception of operations necessarily occurring in a certain order.

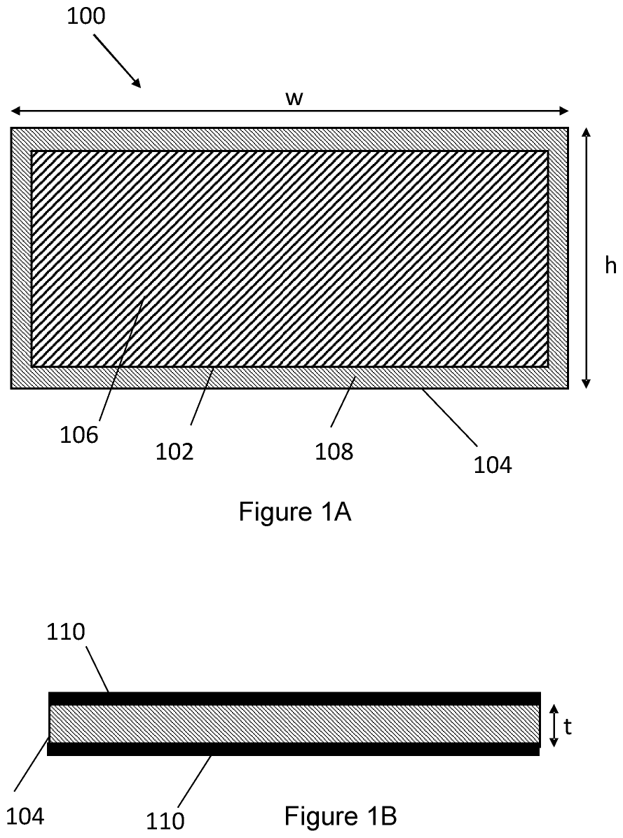

With reference to FIG. 1A, there is illustrated a spacer 100 for a battery cell stack 200. FIG. 1A shows a spacer 100 which is generally rectangular in plan view. The spacer 100 includes a compressible pad 102 and a support element 104. The compressible pad 102 is generally rectangular in plan view and includes a first face 106 and an opposing second face (not shown), each of which abuts a face of a corresponding battery cell (not shown) within the battery cell stack 200. As shown in FIG. 1A, the support element 104 is a generally rectangular frame which extends around an outer periphery of the compressible pad 102. The support element 104 comprises a first support face 108 and an opposing second support face (not shown), each of which also abuts a corresponding battery cell (not shown) within the battery cell stack 200.

In some examples, the first face 106 and/or the second face of the compressible pad 102 and/or the first support face 108 and/or the second support face of the support element 104 will not directly abut a battery cell. In some examples, a layer of adhesive, e.g. an adhesive tape, is disposed between the battery cell and the relevant face(s) of the spacer 100. The spacer 100 is substantially symmetrical such that the first face 106 of the compressible pad 102 and the first support face 108 of the support element 104 form a first face of the spacer 100 and there is also an opposing second face on the other side of the spacer 100, including the second face of the compressible pad 102 and the second support face of the support element 104, which allows the spacer 100 to be sandwiched between two battery cells.

With particular reference to FIG. 1A, the spacer 100 has a width dimension, denoted by the reference “w” and a height direction denoted by the reference “h”. Each of the compressible pad 102 and the support element 104 extend in the same height and width directions. The support element 104 comprises a central aperture, in which the compressible pad 102 is located. The compressible pad 102 located within the central aperture is designed to deform under load. Battery cells expand during their lifetime. In the absence of a volume to expand into, the lifespan of battery cells within a battery cell stack and/or a battery may be reduced. Advantageously, providing a spacer 100 having a support element 104 with a central aperture within which a compressible pad 106 is located provides such a volume into which the battery cells can expand.

The compressible pad 102 serves several functions within the battery cell stack. In various embodiments of the invention, the compressible pad 102 will provide one or more of these benefits. The compressible pad 102 may, for example, provide a thermal barrier between adjacent battery cells in the battery cell stack. The compressible pad 102 may, for example, include an anti-thermal propagation (ATP) material. This barrier function may be beneficial in preventing or alleviating thermal events in batteries. For example, if one cell begins to heat up outside of ideal conditions, then the compressible pad provides a barrier to prevent the heat spreading to neighbouring battery cells within in the battery cell stack. A further benefit may be the formation of an electrical barrier between the battery cells in the battery cell stack. The compressible pad 102 may be formed of a material which has a high electrical resistivity. The compressible pad 102 may, for example, include a material having dielectric properties or being a dielectric material. As such, the compressible pad 102 provides protection from potential short circuits between the battery cells or other components in the battery and/or the battery cell stack.

The support element 104 and the compressible pad 102 have different material properties, including different compressibilities and Young's moduli. The support element 104 is made from and/or comprises a material which deforms less for a given applied load or pressure, i.e. is less compressible, than the compressible pad 102. Put another way, the compressible pad 102 may have a lower Young's modulus, i.e. is less stiff or can be more easily compressed or deformed under applied stress, than the support element 104. The compressible pad 102 may have a Young's modulus 10-100 times lower than the support element 104. Over the lifetime of a battery, the battery cells will expand; that is, their volume will increase. Providing the compressible pad 102 within the support element 104 advantageously provides a volume for the battery cells to expand into, because the compressible pad 102 will deform preferentially relative to the support element 104, due to the higher Young's modulus of the support element 104.

With reference to FIG. 1B, there is illustrated a side view of the spacer 100 of FIG. 1A with an adhesive 110 on opposing sides of the spacer. The thickness dimension of the spacer (the spacer thickness) is denoted by reference “t”. In examples of the invention, the spacer may have a thickness t of at least 1 mm. In other examples, the spacer may have a thickness of at least 0.8 mm. The adhesive is provided on the support element 104 or the compressible pad (not shown) or both. In some examples, the adhesive 110 is used to attach the compressible pad 102 to the support element 104. In some embodiments, the adhesive(s) may be used to attach, adhere or fix the spacer 100 to a battery cell on either side of the spacer 100 or to battery cells on both sides of the spacer 100. It will be understood by the skilled person that there are a plurality of appropriate adhesives which can be used in this context. A non-exhaustive list of appropriate adhesives includes adhesive tape, e.g. double-sided adhesive tape, any wet applied adhesive, structural adhesive or curable adhesive.

Referring now to FIG. 1C, there is illustrated an example of a front view of the spacer 100 to which four pieces or lengths of adhesive tape 110 have been applied. Each piece of the adhesive tape 110 overlaps a portion of the compressible pad 102 and a portion of the support element 104 such that the adhesive tape fixes, adheres or attaches the compressible pad 102 within the central aperture of the support element 104. Each piece of the adhesive tape 110 may be double-sided such that a first face or side of each piece of the adhesive tape 110 is adhered to a portion of the compressible pad 102 and a portion of the support element 104 and an opposing second face or side of each piece of the adhesive tape 110 is adhered to a battery cell such that the spacer 100 may be fixed, adhered or attached to the battery cell.

Referring now to FIG. 1D, there is illustrated an example of a front view of a battery cell 202. The battery cell includes a first face 203 and an opposing second face (not shown). In some example battery cell stacks, the first face 203 and the second face (not shown) will directly abut a spacer 100. In other examples, an adhesive, an adhesive layer or an adhesive tape may attach the spacer 100 to the first face 203 and the second face (not shown). In various examples, the support element 104 or the compressible pad 102 or each of the support element 104 and the compressible pad 102 may be in direct contact with the first face 203 of the battery cell 202. Alternatively, an adhesive, an adhesive layer or an adhesive tape may attach the or each of the support element 104 or the compressible pad 102 or each of the support element 104 and the compressible pad 102 to the battery cell 202.

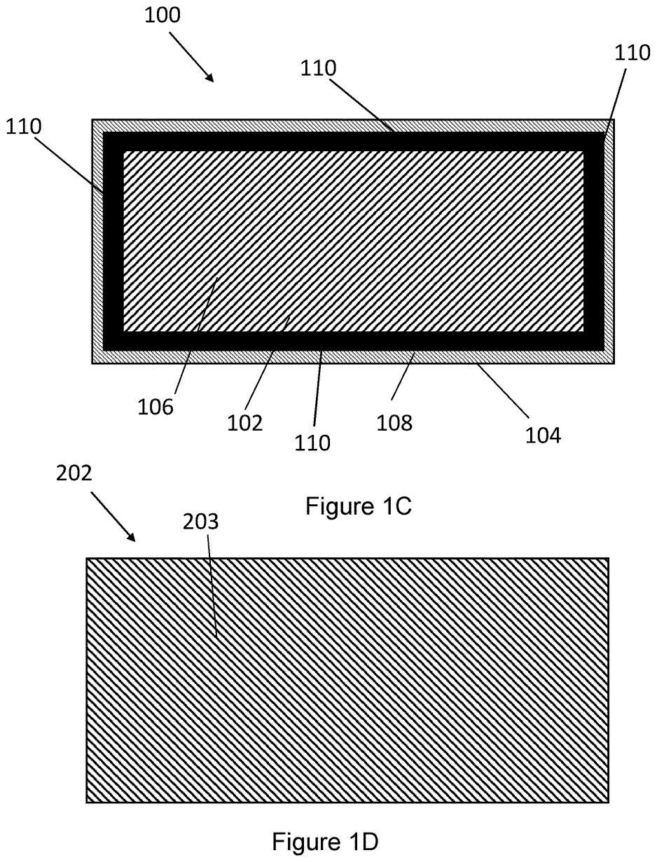

With reference to FIG. 2, there is illustrated a battery cell stack 200. A battery cell stack 200, also known as a battery stack, is a series of individual battery cells 202 that are connected together by a busbar (not shown), or similar, in an electrically-parallel configuration. The present disclosure relates generally to prismatic battery cells however the battery cells may be pouch cells or cylindrical cells. Multiple battery cells 202 are stacked together, generally by a busbar or other connection means. This allows the voltage of the individual battery cells to add up, resulting in a higher overall voltage for the battery cell stack. Battery cell stacks are commonly used in a wide range of applications, including electric vehicles, renewable energy systems, and portable electronic devices, among others.

As shown in FIG. 2, the spacers 100 of the present invention are sandwiched between battery cells 202, such that a battery cell stack 200 comprises a plurality of battery cells 202 and spacers 100. In some examples, end plates 204A, 204B connect to respective outermost battery cells 202A, 202B. In alternative examples, an outermost spacer may be located between the end plates 204A, 204B and the outermost battery cells 202A, 202B. During manufacture of the battery cell stack 200, the battery cells 202 and/or the spacers 100 may be compressed relative to their free shape. To ensure that the components of battery cell stack 200 remain in their compressed state a support bracket 208 may be attached to the end plates 204A, 204B using an attachment means 206A, 206B, such as a rivet, bolt, weld or similar. In some examples, two brackets 208 may be used, each including attachment means 206A, 206B.

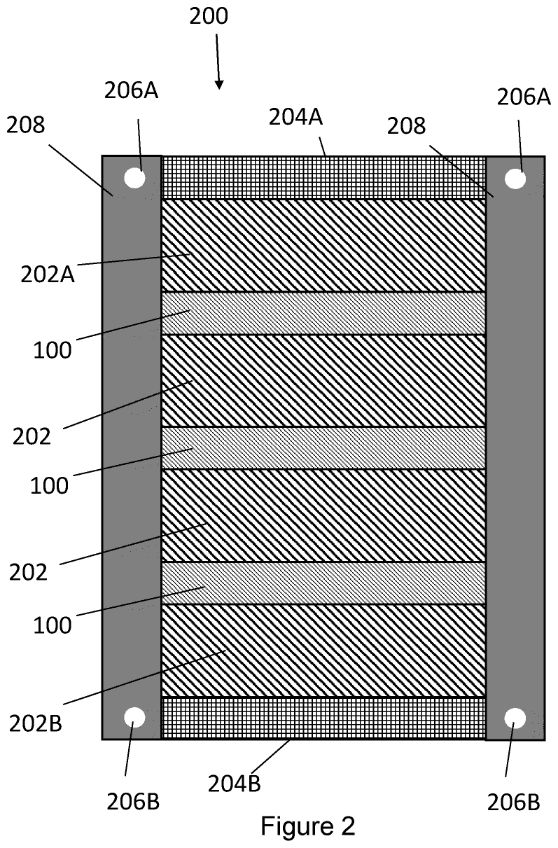

FIG. 3 shows a flowchart 300 depicting a method of assembling a battery cell stack for a battery, the method includes: providing a first battery cell at 302; providing a second battery cell, adjacent to the first battery cell at 304; positioning a spacer between the first battery cell and the second battery cell at 306; and urging the first battery cell and the second battery cell together such that the compressible spacer is at least partially compressed at 308.

The method 300 of FIG. 3 provides various optional method steps including providing a plurality of battery cells and a plurality of spacers and wherein a spacer of the plurality of spacers is positioned between each of the battery cells of the plurality of battery cells at 310. According to a further optional method step, the method further includes providing an adhesive and securing said battery cells to said spacer or spacers using said adhesive at 312. According to a further optional method step, the method further includes providing a jig and urging said battery cells together using the jig at 314. According to a further optional method step, the method further includes adhering or otherwise attaching or fixing a support bracket to the or each spacer at 316.

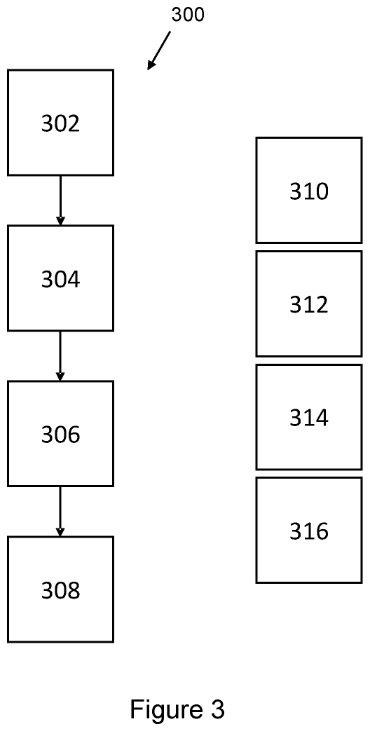

FIG. 4 shows a segment of a battery 400 comprising a plurality of battery cell stacks 200. The battery cell stacks may be attached in series or in parallel. Additionally, the battery cell stacks may be in contact with a cooling plate, with either the spacer or battery cells in contact with the cooling plate (not shown). The battery cell stacks may be adjacent or stacked on top of each other or both stacked and adjacent to each other. There may be an air gap or housing between the battery cell stacks 200.

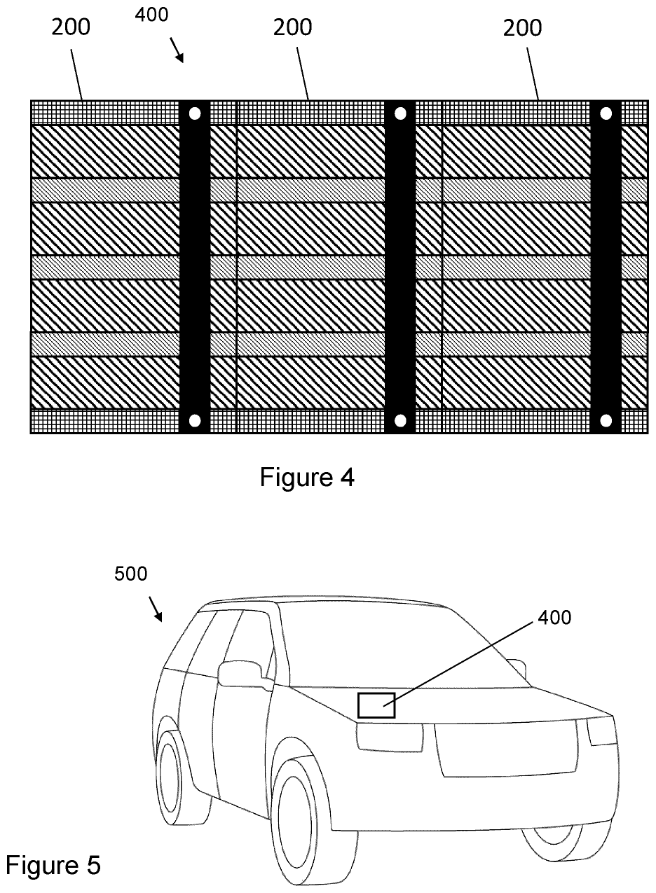

A vehicle 500 in accordance with an embodiment of the present invention is described herein with reference to the accompanying FIG. 5. The vehicle includes a battery 400 in accordance with examples of the present invention. The vehicle 500 in the present embodiment is an automobile, such as a wheeled vehicle, but it will be understood that the battery spacer 100, battery cell stack 200 or battery 400 described above may be used in other types of vehicle, such as aircraft, watercraft etc. as well as in homes.

It will be appreciated that various changes and modifications can be made to the present invention without departing from the scope of the present application.

In the example described above, the compressible pad 102 is generally rectangular in plan view. It will be understood that, in other examples of the invention, the compressible pad may be any shape in plan view.

In the example described above, the support element 104 is a generally rectangular frame which extends around an outer periphery of the compressible pad 102. In other examples of the invention, the support element may support part of the compressible pad 102. The support element may have an upper edge and/or a lower edge and/or a first side edge and/or a second side edge of the compressible pad 102. The support element may be, for example, L-shaped or U-shaped in section. In other examples of the invention, a portion of the support element may extend across a central portion of the compressible pad 102. The support element may be, for example, H-shaped in section in this case.

In the example described above, an adhesive, for example an adhesive tape, is provided between the battery cell and the relevant face(s) of the spacer 100. It will be understood that, in alternative examples of the invention, an adhesive glue may be provided between the battery cells and the relevant face(s) of the spacer 100.

The adhesive, for example the adhesive tape or adhesive glue is provided to adhere the respective spacer(s) 100 and battery cells. It will be understood that, in alternative examples of the invention, other suitable methods of fixing the respective spacer(s) 100 and battery cells may be provided, for example heat sealing.

1. A spacer for positioning between two adjacent battery cells of a battery cell stack, the spacer comprising:
a compressible pad; and
a support element supporting the compressible pad,
wherein the compressible pad and the support element are configured to be at least partly compressed between two adjacent battery cells of the battery cell stack.

2. The spacer of claim 1 wherein the compressible pad comprises two faces, and each face of the compressible pad is configured to abut a face of a battery cell of the battery cell stack.

3. The spacer of claim 2 comprising an adhesive on at least one face of the compressible pad, wherein the adhesive is configured to at least partly adhere the spacer to a first battery cell of the two adjacent battery cells.

4. The spacer of claim 3 comprising the adhesive on each face of the compressible pad, wherein the adhesive is configured to at least partly adhere the spacer to the first battery cell and a second battery cell of the two adjacent battery cells.

5. The spacer of claim 1 wherein the support element has a first compressibility and the compressible pad has a second compressibility.

6. The spacer of claim 5 wherein the first compressibility is lower than the second compressibility.

7. The spacer of claim 1 wherein the compressible pad is attached to the support element.

8. The spacer of claim 1 wherein the support element is a frame, which frame at least partly surrounds a perimeter of the compressible pad.

9. The spacer of claim 1 wherein the compressible pad comprises an anti-thermal propagation material.

10. The spacer of claim 1 wherein the compressible pad comprises a dielectric material.

11. The spacer of claim 1 wherein the support element comprises a thermoplastic elastomer.

12. The spacer of claim 1 wherein the spacer is at least 1 mm thick.

13. A battery cell stack comprising:
a first spacer according to claim 1, the first spacer being sandwiched between a first battery cell and a second battery cell.

14. A battery cell stack according to claim 13 comprising:
a second spacer sandwiched between one of the first battery cell and the second battery cell and a third battery cell.

15. A battery comprising a battery cell stack according to claim 13.

16. A vehicle comprising a battery cell stack according to claim 13.
